(19) United States
(12) Patent Application Publication
(10) Pub. No.: US 2008/0244622 A1
(43) Pub. Date: Oct. 2, 2008

(54) Printer Driver Program and Printer System Having Same

(75) Inventor: Shuji WAKUMOTO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/053,125

(22) Filed: Mar. 21, 2008

(30) Foreign Application Priority Data
Mar. 26, 2007 (JP) 2007-078959
Jan. 15, 2008 (JP) 2008-005700

(51) Int. Cl. G06F 3/00; G06F 15/00

(52) U.S. Cl. 719/327; 358/1.15

(57) ABSTRACT

A printer driver program which is improved in convenience of the form overlay function, and a printer system having the printer driver program are provided. A printer driver program, which is installed in a host computer and controls a print job request sent to a printer, wherein a computer is caused to execute a batch display procedure for, in response to batch designation for designating all of a plurality of recording media incorporated in or attached to the printer, extracting from the printer form information items that are already registered in the plurality of recording media of the printer and then displaying the extracted form information items onto the host computer, during a form overlay setting step.

### CROSS-REFERENCE TO RELATED APPLICATIONS

This application is based upon and claims the benefit of priority from the prior Japanese Patent Application No. 2007-078959, filed on Mar. 26, 2007, and Japanese Patent Application No. 2008-5700, filed on Jan. 15, 2008, the entire contents of which are incorporated herein by reference.

### BACKGROUND OF THE INVENTION

1. Field of the Invention

The present invention relates to a printer driver program which is improved in convenience of the form overlay function, and a printer system having the printer driver program.

2. Description of the Related Art

A form overlay function is a function of generating beforehand a fixed form such as a letter head and invoice, recording and registering the data of the form in a memory provided within a printer, superimposing the registered form on an image generated by an application, and printing thus obtained image. Because the form data is recorded in the memory provided within the printer, once a host computer transmits print data of document generated by the application to the printer as a print job, an image processing unit of a controller provided within the printer can overlap the image of the form on the image of the print data, and print thus obtained image. The host computer does not have to transfer the form data to the printer, hence, as long as the form data is recorded within the printer memory in the form of an intermediate code corresponding to the printer, high-speed printing can be performed without requiring conversion of the form data into the intermediate code for every print job.

The printer with the form overlay function is described in, for example, Japanese Published Unexamined Patent Application H09-188023 and Japanese Published Unexamined Patent Application No. 2000-112697.

Japanese Published Unexamined Patent Application No. H09-188023 describes that form data is registered by a host computer into an external memory of a printer, and, when printing, the form data registered in the external memory is used to realize the form overlay function.

Japanese Published Unexamined Patent Application No. 2000-112697 describes that a web server is caused to manage form data open information indicating which one of a plurality of printers connected to a network registers form overlay data, and then a transfer destination printer to which print data is transferred is specified with reference to the form data open information when executing form overlay printing.

In recent years, in response to the diversification of users' needs, there has been proposed to equip a hard disk or a semiconductor memory in a printer or to make a USB memory, a card memory, or other external memory detachable to the printer. There has also been proposed a printer capable of externally attaching an external memory without incorporating a hard disk.

In such a diversity-carrying printer, when the form overlay function is realized, registered forms within various recording media need to be selected. Therefore, even in the diversity-carrying printer, simplicity is required in use of the form overlay function.

### SUMMARY OF THE INVENTION

An object of the present invention is, therefore, to provide a printer driver program which is improved in convenience of the form overlay function, and a printer system having the printer driver program.

In order to achieve the above object, a printer driver of the first aspect is a printer driver program, which is installed in a host computer and controls a print job request sent to a printer, wherein a computer is caused to execute: a batch display procedure for, in response to batch designation for designating all of a plurality of recording media to be incorporated in or attached to the printer, extracting from the printer form information items that are already registered in the plurality of recording media of the printer and then displaying the extracted form information items onto the host computer, during a form overlay setting step; and an individual display procedure for, in response to individual designation for designating any of the plurality of recording media to be incorporated in or attached to the printer, extracting from the printer form information items that are already registered in the designated recording medium and then displaying the extracted form information items onto the host computer, during the form overlay setting step.

By using the batch designation, not only the recording media provided within the printer but also external recording media to be attached by a user can be handled virtually as one type of recording medium, and the form information items that are registered in these recording media can be displayed, whereby the convenience of the user is improved.

In the first aspect described above, according to a preferred mode, the printer driver program further causes the computer to execute a transfer procedure for transferring, in response to selection of a form information item from among the displayed form information items, print data and the selected form information item to the printer as print jobs, during the form overlay setting step.

In the first aspect described above, according to a preferred mode, in the batch display procedure the plurality of extracted form information items are displayed in a display order corresponding to priority levels set for the plurality of recording media.

In the first aspect described above, according to a preferred mode, in the batch display procedure, recording medium information items corresponding to the extracted form information items are displayed so as to correspond to the form information items.

In order to achieve the above object, a printer system of the second aspect has: the printer driver program of the above-described first aspect; and a printer to which an external recording medium can be attached and which, in response to a request of a print job that is sent from the host computer, reads from the recording medium form image data corresponding to form information items contained in the print job, superimposes a print image of print data contained in the print job on a form image of the form image data, and prints thus obtained image.

In order to achieve the above object, a printer driver program of the third aspect is a printer driver program, which is installed in a host computer and controls a print job request sent to a printer, wherein a computer is caused to execute a batch display procedure for, in response to batch designation for designating all of a plurality of recording media incorporated in or attached to the printer, displaying form information items recorded in the plurality of recording media of the printer onto the host computer, during a form overlay setting step.

According to a preferred mode of the third aspect described above, the printer driver program further causes the computer to execute a latest form information monitoring procedure for maintaining the form information items up-to-date at the appropriate time, the form information items being recorded in the recording media incorporated in or attached to the printer.

According to a preferred mode of the third aspect described above, the printer driver program further has a procedure for recording a form information list, which has at least a form name corresponding to each of the recording media, in each of the recording media, wherein the latest form information monitoring procedure has a procedure for requesting a controller of the printer the latest form information items on regular basis, and a procedure for receiving, in response to the request, the latest form information items that are transmitted by the controller of the printer and then updating the form information list.

According to a preferred mode of the third aspect described above, the printer driver program further has a procedure for recording a form information list, which has at least a form name corresponding to each of the recording media, in each of the recording media, wherein the latest form information monitoring procedure has a procedure for receiving the latest form information items that are transmitted by the controller of the printer in response to changes in the conditions of the recording media, and then updating the form information list.

In order to achieve the above object, a printer driver program of the fourth aspect is a printer driver program, which is installed in a host computer and controls a print job request sent to a printer, wherein a computer is caused to execute a display procedure for, in response to designation of an external recording medium attached to the printer, displaying a form information item recorded in the external recording medium onto the host computer, during a form overlay setting step.

### BRIEF DESCRIPTION OF THE DRAWINGS

FIG. 1 is a configuration diagram of a printer system of a present embodiment;

FIG. 2 is a diagram showing an example of a form selection window of the present embodiment;

FIG. 3 is a diagram showing another example of the form selection window of the present embodiment;

FIG. 4 is a diagram showing yet another example of the form selection window of the present embodiment;

FIG. 5 is a diagram showing an example of a priority level setting window of the present embodiment;

FIG. 6 is a diagram showing a processing flowchart of a printer driver shown on the form selection window;

FIG. 7 is a flowchart of print processing performed by a printer controller;

FIG. 8 is a diagram showing configurations of the printer driver and the printer controller of Modified Example 1 of the present embodiment;

FIG. 9 is a flowchart showing a procedure of a form information list update routine 62;

FIG. 10 is a flowchart of a latest form information monitoring routine 52 and a latest form information list notification routine 64 of Modified Example 1;

FIG. 11 is a diagram showing configurations of the printer driver and the printer controller of Modified Example 2 of the present embodiment;

FIG. 12 shows flowcharts of a latest form information monitoring routine 56 and a latest form information list notification routine 66 of Modified Example 2; and

FIG. 13 is a processing flowchart of the printer driver shown in the form selection window of Modified Examples 1 and 2.

### DESCRIPTION OF THE PREFERRED EMBODIMENTS

Hereinafter, an embodiment of the present invention will be described with reference to the drawings. However, the technical field of the present invention is not limited to this embodiment, but extends to the matters described in the patent claims and equivalents thereof.

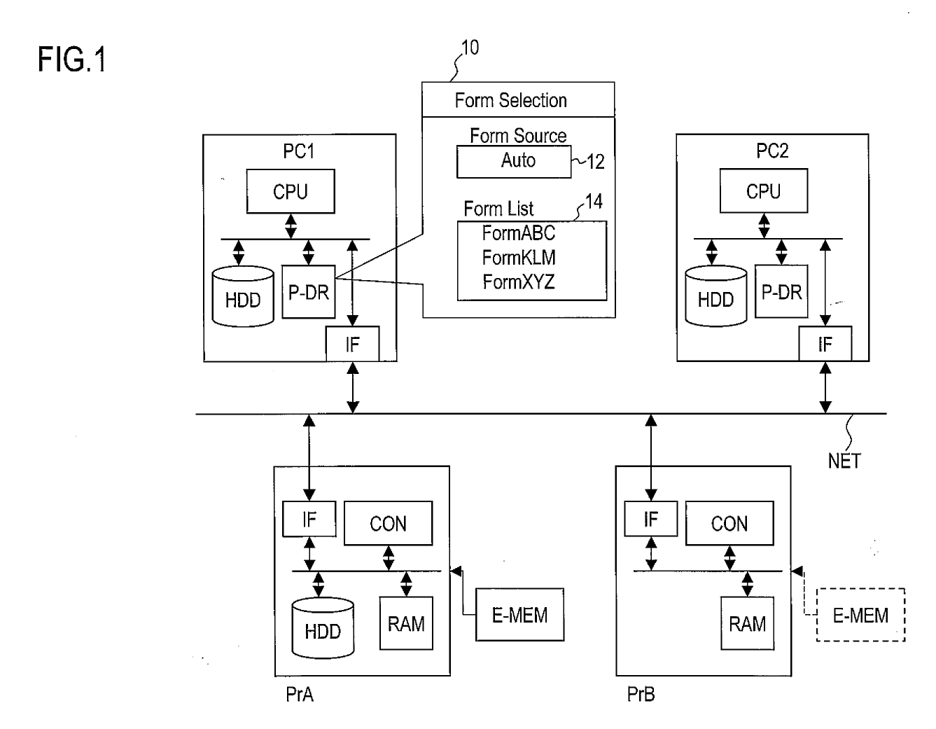

FIG. 1 is a configuration diagram of a printer system of the present embodiment. In FIG. 1, two host computers PC1, PC2 are connected to two printers PrA, PrB via a network NET such as a LAN. Each of the host computers PC1, PC2 has an central processing unit CPU, a built-in hard disk HDD, and a network interface IF. Each of the host computers PC1, PC2 further is installed with a printer driver P-DR of each of the two printers PrA, PrB.

The printer PrA has a network interface IF, a controller CON for interpreting the print data, performing image processing and print control, a built-in hard disk HDD, and a built-in RAM, and is further attached with an external memory E-MEM in a detachable manner. The printer PrB, on the other hand, has a network interface IF, a controller CON for performing image processing and print control, and a built-in RAM, and is attachable with an external memory E-MEM. However, the printer PrB does not have a built-in hard disk HDD and is not attached with the external memory E-MEM. Moreover, either of the printers has a print engine, not shown. The print engine carries out printing. The print engine normally includes a paper transport mechanism, image exposure unit, image development unit, and image transfer unit and so on.

The external memory E-MEM is an external memory such as a USB memory, a card memory, a hard disk, or a CD-ROM (with a CD-ROM drive). In addition to the built-in hard disk, the external memory E-MEM is attachable to the printer PrA so that the convenience of the user can be improved. On the other hand, because the built-in hard disk HDD is not attached to the printer PrB, significant cost reduction can be achieved. On the other hand, by making the external memory E-MEM attachable, form data and the like can be stored in the external memory without incorporating a hard disk.

Form overlay data is generated at, for example, the host computers PC1, PC2 and stored in the built-in HDDs or built-in RAMs of the printers PrA, PrB by the printer drivers P-DR (or a utility program, which is not shown) A process of registering the form data into a recording medium of each printer has a process that is partially the same as normal print processing. Specifically, in response to a request regarding registration of form data, which is sent from each printer driver P-DR, the corresponding controller CON of the corresponding printer converts the form data described in a page-description language into an intermediate code that is unique to the printer. This process is the same as a conversion process of converting print data into an intermediate code in the normal print processing. Then, the intermediate code of this form is stored in the built-in recording media HDD, RAM. In the normal print processing, the intermediate code converted from print data is developed into bit map data, and a print engine forms an image on the printing medium corresponding to the bit map data.

Alternatively, the form data can be registered into the external memory E-MEM as well that is attachable to the printer. Therefore, an external memory, such as a highly portable USB memory, is attached to a certain printer, form data that is created in the host computer can be registered in the USB memory, and this USB memory can be attached to other printer to use the form overlay function.

Next, when carrying out printing using a form overlay, a user generates a desired document or image by using application software and starts the printer driver P-DR for the printing of the documents or image on the host computer PC1, PC2. Then, user selects a form information item in a form overlay setting step of the corresponding printer driver P-DR. In the form overlay setting step, the form information items (form names and recording media) registered in the built-in HDD, the built-in RAM, and the external memory E-MEM of a designated printer are displayed on a form selection window on a display device of the host computer, and then a form information item is selected.

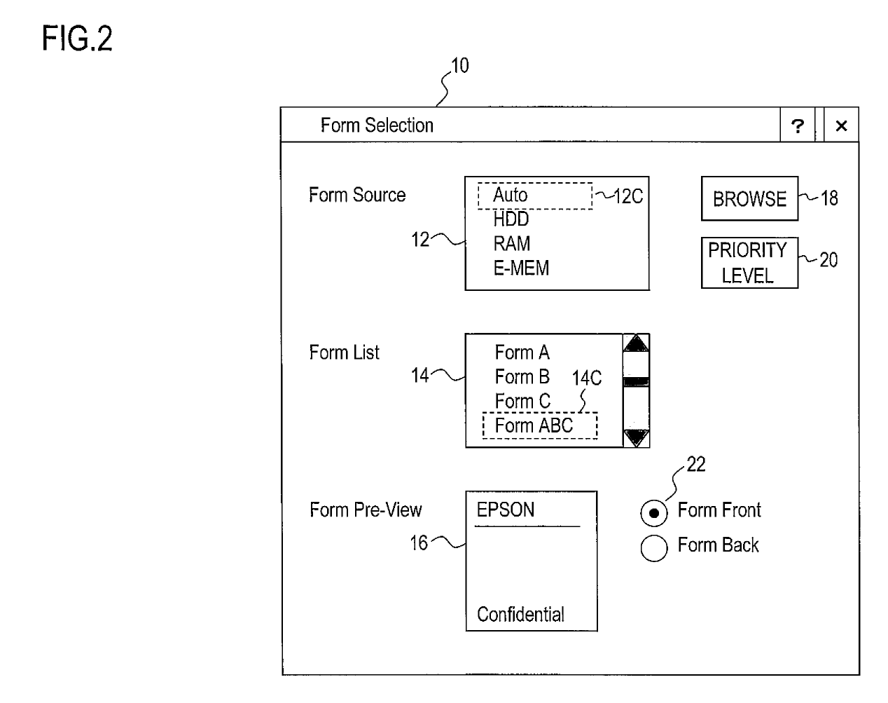

A form selection window 10 shown in FIG. 1 has a recording medium selection portion 12 in which form data are stored, and a form list portion 14 registered in a selected recording medium. In the example shown in FIG. 1, a batch display mode Auto for handling all of the recording media provided within and attached to the printer as one virtual recoding medium is selected, and the form names within all of the recording media are displayed on the form list portion 14. The form selection window 10 is also shown in FIGS. 2, 3 and 4.

Once a form is selected on the form selection window on the host computer, print job data that has print data written in the page-description language and the form information on the selected form is transferred from the host computer to the printer. The controller CON of the printer extracts the form information items from the print job data, and reads form data corresponding to the form information items from the built-in recording medium or external recording medium. Furthermore, the controller CON of the printer extracts the print data from the print job data and converts it into an intermediate code. The printer controller CON then develops the intermediate code of the print data and the intermediate code of the form data into bit map data in the built-in RAM according to a superimposition rule (for designating whether the form is placed on top or bottom). The printer engine prints the image on the printing medium on the basis of the bit map data.

The host computer transmits the form information items only to the printer, and the printer reads the form data in the form of a converted intermediate code, and develops the form data into bit map data to perform image formation. Accordingly, high-speed printing can be performed using the form overlay function.

It should be noted that the form data can also be registered in the memories provided within the host computer. In this case, however, the print data and the form image data are included in the print job data that is transferred by the host computer to the printer. The present embodiment is based on the assumption that the form data is registered in the recording medium of the printer.

Each printer is capable of responding to a variety of recording media, for example the hard disk HOD and semiconductor memory RAM are attached thereto as built-in recording media, and the external memory E-MEM can also be attached to the same. When using the form overlay function in such a printer, the user is requested to select a desired form from the various recording media attached to the printer. However, the user needs to know beforehand in which recording medium the form data is stored, and a step of selecting a form is troublesome.

Therefore, in the present embodiment, in the form selection step of the printer driver on the host computer, the printer driver is provided with a batch display function for handling the plurality of recording media of the printer as one virtual recording medium and displaying form information items recorded in the plurality of recording media in a batch.

FIG. 2 is a diagram showing an example of the form selection window of the present embodiment. This form selection window 10 is one of setting windows of the printer driver P-DR, and the printer PrA for performing printing has already been selected on a window, not shown. When this form selection window 10 is selected, the printer driver P-DR receives, from the printer controller CON, the information on the recording media attached to the printer PrA, and displays the names of the recording media to the recording medium selection portion 12. Then, the user can use the recording medium selection portion 12 to select to perform either individual selection for selecting any one of the recording media HDD, RAM and E-MEM that are attached to the printer, or batch selection for selecting all of the recording media as one virtual recording medium Auto.

When the user selects the virtual recording medium Auto on the recording medium selection portion 12 and clicks a browse button 18 using a cursor 12C, the printer driver P-DR transmits a relevant batch display request to the printer. In response to this batch display request, the printer controller CON extracts the form information items that are already registered in all of the attached recording media, and transmits them to the host computer. The form information items include the form names, registered recording medium information, thumbnail image data of the form, and the like. Then, the printer driver P-DR displays the form names included in the received form information items, on the form list portion 14. In this case, the recording medium information may be displayed at the same time.

When the user selects a desired form name from the form names displayed in a batch on the form list portion 14 by using a cursor 14C, the printer driver displays an image of the form selected by user included in the form information items, on a form preview portion 16. This image is made based on, for example, the thumbnail image data described above. Moreover, the user uses a superimposition setting portion 22 to select whether to superimpose the selected form on a print data (Form Front) or to superimpose it under the print data(Form Back).

It should be noted that a priority level button 20 is a button for arbitrarily setting an order of recording media to be displayed when a batch selection Auto is selected in relation to the recording media. This priority level setting will be described hereinafter.

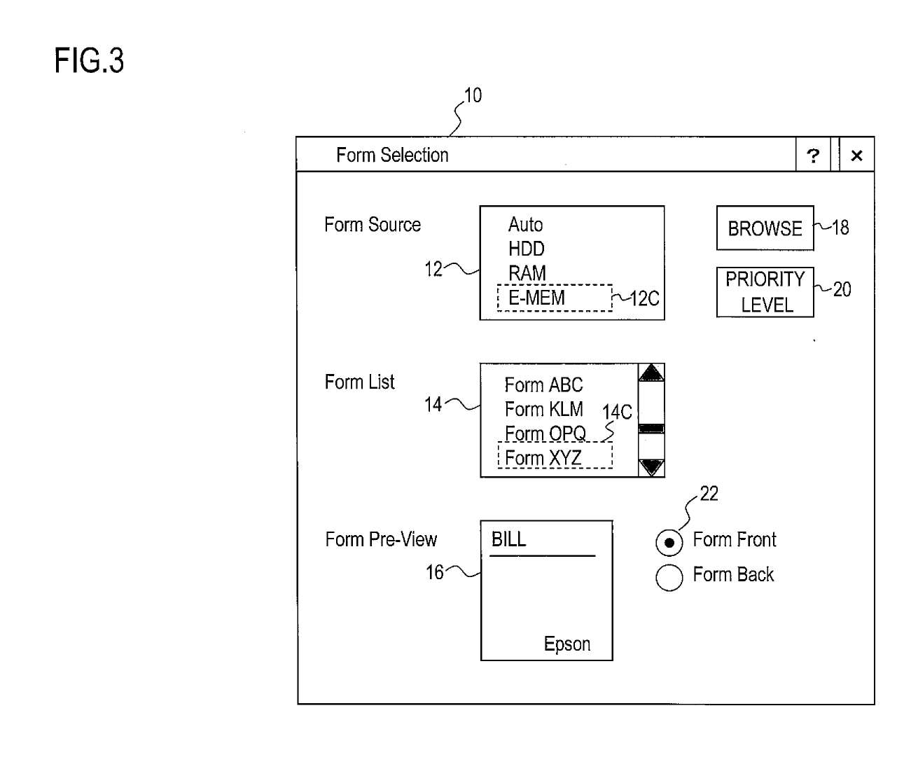

FIG. 3 is a diagram showing another example of the form selection window of the present embodiment. On this form selection window 10 as well, the printer PrA for performing printing has already been selected on the unshown window. Therefore, the recording medium selection portion 12 displays a list having the recording media HDD, RAM and E-MEM attached to the printer PrA and the virtual recording medium Auto. When the user selects the external memory E-MEM on the recording medium selection portion 12 and clicks the browse button 18 using the cursor 12C, the printer driver P-DR transmits a relevant individual display request to the printer. In response to this individual display request, the printer controller CON extracts the form information items that are already registered in the selected recording medium E-MEM, and transmits them to the host computer. The printer driver P-DR then displays the form names included in the received form information items, on the form list portion t 14. The form preview portion 16 and the superimposition setting unit 22 are used in the same manner described above.

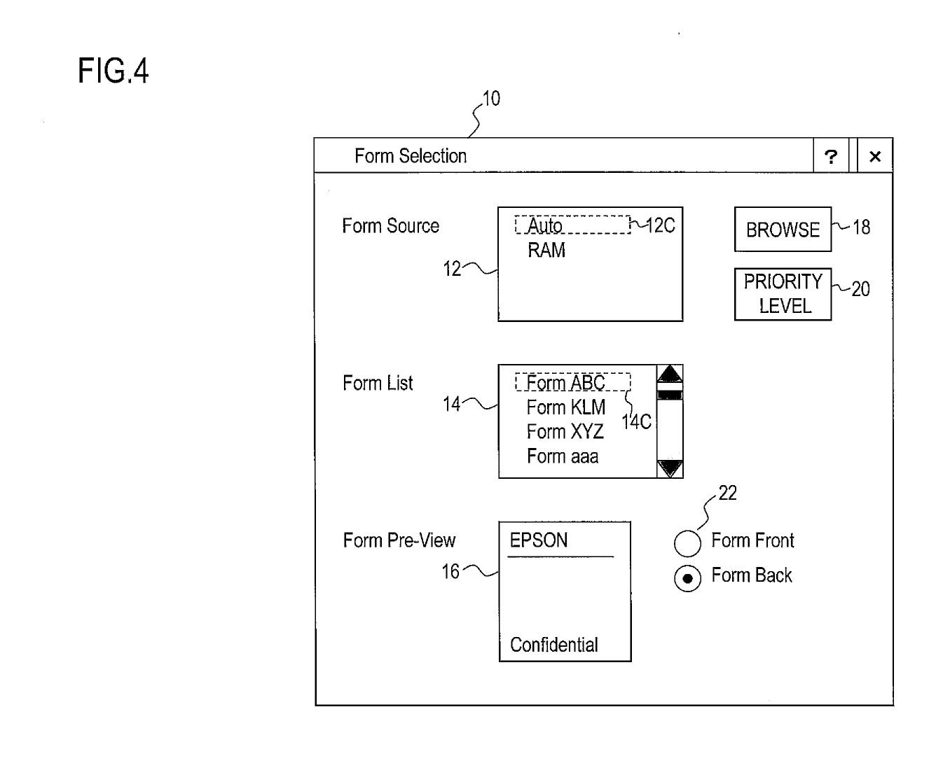

FIG. 4 is a diagram showing yet another example of the form selection window of the present embodiment. In this form selection window 10, the printer PrB for performing printing has already been selected on the unshown window. Therefore, a list having the recording medium RAM attached to the printer PrB and the virtual recording medium Auto is displayed on the recording medium selection portion 12. When the user selects the virtual recording medium Auto on the recording medium selection portion 12 and clicks the browse button 18 using the cursor 12C, the printer driver P-DR transmits a relevant batch display request to the printer. In response to this batch display request, the printer controller CON extracts the form information items that are already registered in all of the attached recording media attached to the printer, and transmits them to the host computer. The printer driver P-DR then displays the form names included in the received form information items, on the form list portion 14. The form preview portion 16 and the superimposition setting portion 22 are used in the same manner described above.

It should be noted that the operation that is performed in an individual display mode when the printer PrB is selected and the actual recording medium other than the virtual recording medium is selected is same as the operation described using FIG. 3.

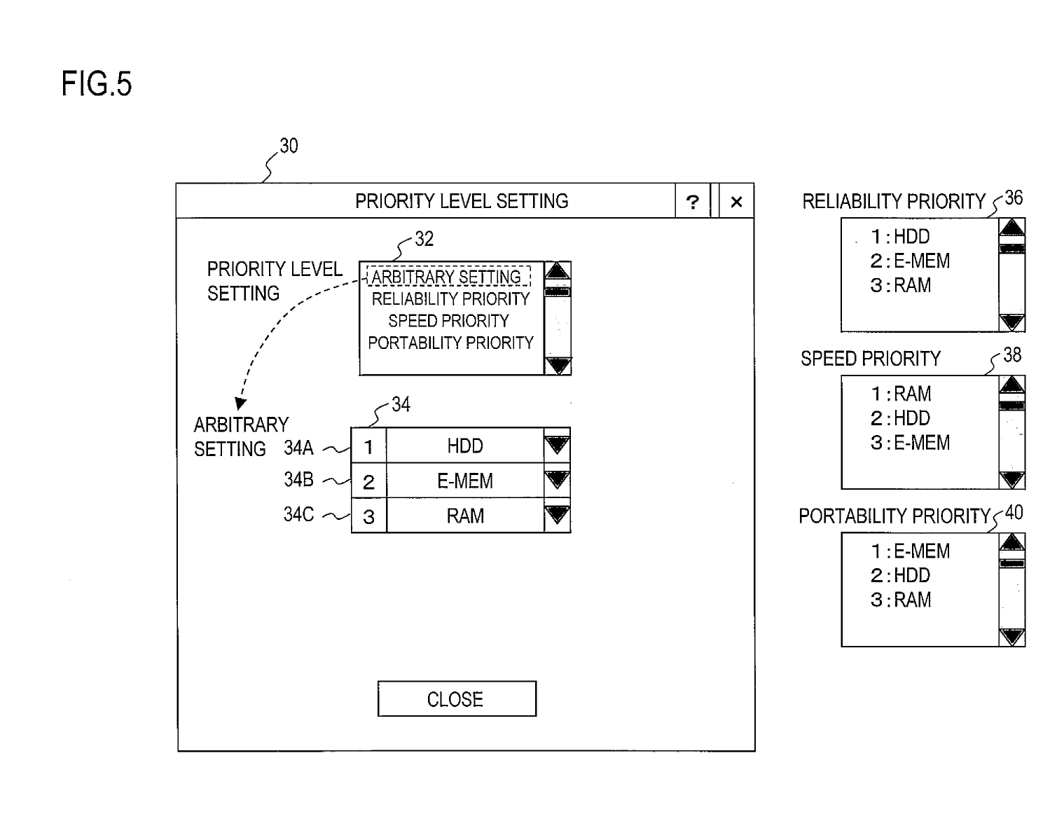

FIG. 5 is a diagram showing an example of a priority level setting window of the present embodiment. When the priority level button 20 shown in FIGS. 2 through 4 is clicked, a priority level setting window 30 of FIG. 5 is displayed. This priority level setting window 30 has a priority level setting portion 32 for selecting priority levels, and an arbitrary setting portion 34 that is used when “arbitrary setting” is selected in the priority level setting portion 32. The priority levels are the rule for indicating which recording medium's form name is displayed preferentially, i.e., on the top of the form list, in the case of a batch selection mode for selecting the virtual recording medium Auto in FIGS. 2 through 4.

When the user selects “arbitrary setting” on the priority level setting portion 32, the user then selects the recording media on the arbitrary setting portion 34 in the order of 1, 2 and 3. In the example shown in FIG. 5, the hard disk HDD is selected as a priority level 1 in a selection portion 34A, the external memory E-MEM is selected as a priority level 2 in a selection portion 34B, and the built-in RAM is selected as a priority level 3 in a selection portion 34C. By performing this arbitrary setting, the form names that are registered in the order of HDD, E-MEM and RAM respectively are listed and displayed on the form list portion 14 in the batch selection mode. Moreover, if there exists a registration form having the same form name, only the form name registered in the recording medium of high priority level is displayed. Alternatively, in the case where the recording medium information is displayed along with the form names, both form names are displayed along with the name of the recording medium name.

In the priority level setting portion 32, not only “arbitrary setting” but also “reliability priority,” “speed priority,” “portability priority” and the like can be selected. When “reliability priority” is selected, priority levels are set in the order shown in a priority level list 36 provided on the right side of the diagram. When “speed priority” is selected, priority levels are set in the order shown in a priority level list 38. Also, when “portability priority” is selected, priority levels are set in the order shown in a priority level list 40.

As described above, in the present embodiment, because the print driver has the batch display function for displaying the form information items registered in all of the plurality of recording media attached to the printer, it is possible to improve the convenience of the user in selecting a form from the forms displayed in a batch by using the priority level setting function described above.

Moreover, in the priority level setting function, not only the priority levels of the recording media but also the priority levels of the form names can be selected in the order of the alphabet, the Japanese syllabary, the registration date, the use frequency, and the like.

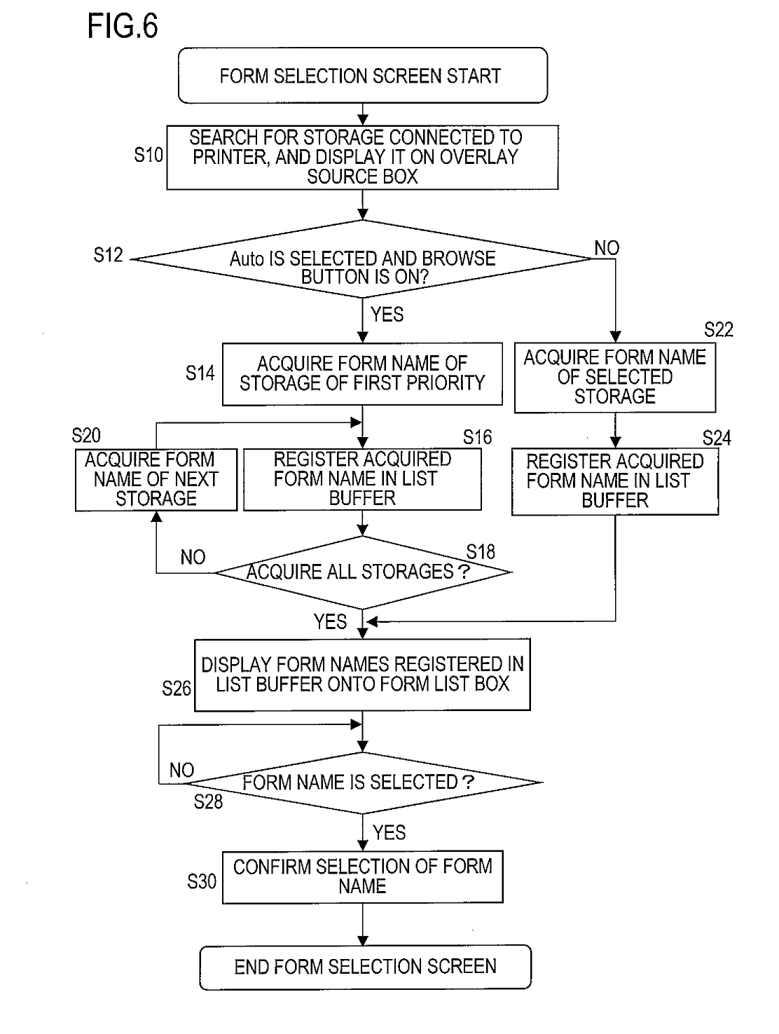

FIG. 6 is a processing flowchart of the printer driver shown on the form selection window. When the form selection window is selected, the printer driver P-DR causes the printer controller to search for the recording media connected to the printer and to return the information on the extracted recording media, and then displays the recording medium information on the recording medium selection portion 12 (S10). When the user selects the virtual recording medium Auto on the recording medium selection portion 12 and clicks the browse button 18, the printer driver P-DR requests the printer controller CON the form information items of the recording medium of the first priority or the recording medium that is set first in the default search order. The printer controller CON then searches for the form data registered in the requested recording medium, and returns the form data (form name, thumbnail image data, and the like). Accordingly, the printer driver acquires the form information items registered in this recording medium (S14). The printer driver then registers the acquired form name in a list buffer (not shown) (S16).

Then, acquisition of the form information items of the next recording medium (S20) and registration of the acquired form name into the list buffer (S16) are repeated until the form information items of all recording media are acquired (S18).

On the other hand, when the user selects any of the individual recording media HDD, RAM or E-MEM and clicks the browse button 18 by using the recording medium selection portion 12, the printer driver P-DR requests the printer controller CON the form information items of the selected recording medium. The printer controller CON searches for the form data registered in the requested recording medium, and returns the form information items (form name, thumbnail image data, and the like). Accordingly, the printer driver acquires the form information items registered in this recording medium (S22). The printer driver then registers the acquired form name in the list buffer (not shown) (S24).

The printer driver displays the form names registered in the list buffer on the form list portion 14 (S26). Then, when the user selects a form name on the form list portion 14, the printer driver displays a form image on the form preview portion 16. When a form name is selected and a “close” button (not shown) is clicked, selection of the form name is confirmed (S30).

In the flowchart described above, the user uses the recording medium selection portion 12 to select any of the recording media that are display in a batch or individually and then clicks the browse button 18, whereby the printer driver requests the printer controller to acquire the registered form information items. Accordingly, even when the highly portable external memory E-MEM is attached at the last minute, the form information items registered in this external memory E-MEM can be acquired on a timely manner and displayed on the form list portion 14.

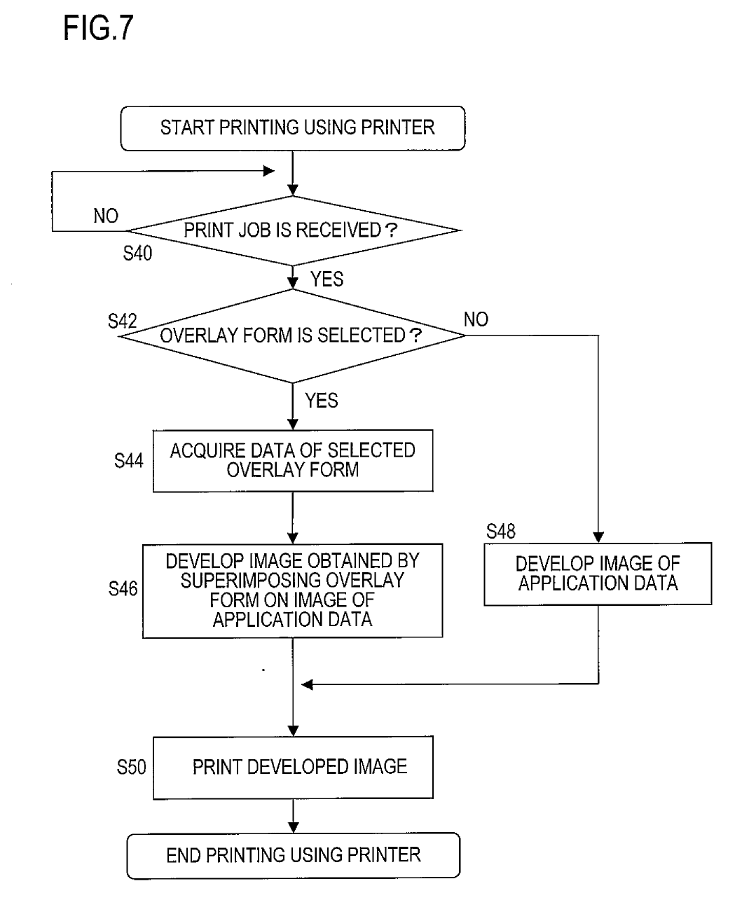

FIG. 7 is a flowchart of print processing performed by the printer controller. When the printer controller CON receives a print job (S40), the printer controller CON analyzes the data of the print job and checks whether or not a form is selected (S42). When a form is selected (YES in S42), the printer controller CON reads the data of the selected form from the attached recording medium (S44). Then, the printer controller CON converts the print data generated by the printer driver into an intermediate code, and develops bit map data of the image on which the form data is superimposed in the built-in memory (S46).

When, on the other hand, a form is not selected (NO in S42), the printer controller converts the print data generated by the application into an intermediate code and develops the bit map data in the built-in memory (S48).

Finally, the printer controller performs necessary image processing such as color conversion, half-tone processing, and resolution modification processing on the developed bit map data, and causes the print engine to execute printing (S50).

It should be noted that when the image data contained in the print job data has already been converted into an intermediate code, the print job data can be developed into the bit map data on the basis of the intermediate code in the steps S46, S48.

As described above, in the present embodiment, because the printer driver of the host computer can display, in a batch, the form information items that are registered in the built-in recording medium and external recording medium attached to the selected printer, the user can view available forms in a batch and select a form, hence the convenience of form selection is improved. Moreover, because the priority level order in the form list can be arbitrarily set when the forms are displayed in a batch, again the convenience of the user can be improved.

In addition, the present embodiment has described an example in which the form data is stored in the recording medium in the form of an intermediate code unique to the printer, but the format of the data to be stored is not limited to this. For example, the form data may be stored as bit map data, or the form data may be converted into bit map data, and the bit map data may be stored as compressed data.

In the embodiment described above, when the form selection window 10 is selected, the printer driver P-DR causes the printer controller CON to extract the attached recording media and return the information items of the extracted recording media, and displays the information items of the recording media on the recording medium selection portion 12. Moreover, when the virtual recording medium Auto or any of the individual recording media HDD, RAM and E-MEM is selected on the recording medium selection portion 12, the printer driver P-DR requests the printer controller CON the form information items of the selected recording medium, and the printer controller CON extracts the form data stored in the requested recording medium and returns the extracted form information items (form name, recording medium name, thumbnail image data, and the like). Then, the printer driver P-DR registers the received form information items in the list buffer and displays the form name on the form list portion 14.

Specifically, the fact that the user selects a recording medium is used as a trigger, and thereby the printer controller CON acquires this recording medium and the form information items registered therein and transmits the form information items to the printer driver P-DR provided in the host computer.

The following, on the other hand, are modified examples of the embodiments described above. In these modified examples, the information items of the devices (recording media) attached to the printer and the form information items of these devices are acquired and updated constantly, and, as soon as the user selects a form setting window, the latest form information items are displayed on the form list portion 14.

### MODIFIED EXAMPLE 1

In Modified Example 1, the printer driver P-DR provided in the host computer monitors the changes in the condition of the printer. Specifically, the printer driver P-DR constantly monitors whether the forms recorded in the recording media incorporated in and attached to the printer are registered or deleted, and whether the portable memories (external memory E-MEM etc.) are attached or detached, and constantly maintains the latest form information items of the recording media in the list buffer. Then, when the user selects the form setting window, the printer driver P-DR reflects the latest form information items in the recording medium selection portion 12 and the form list portion 14.

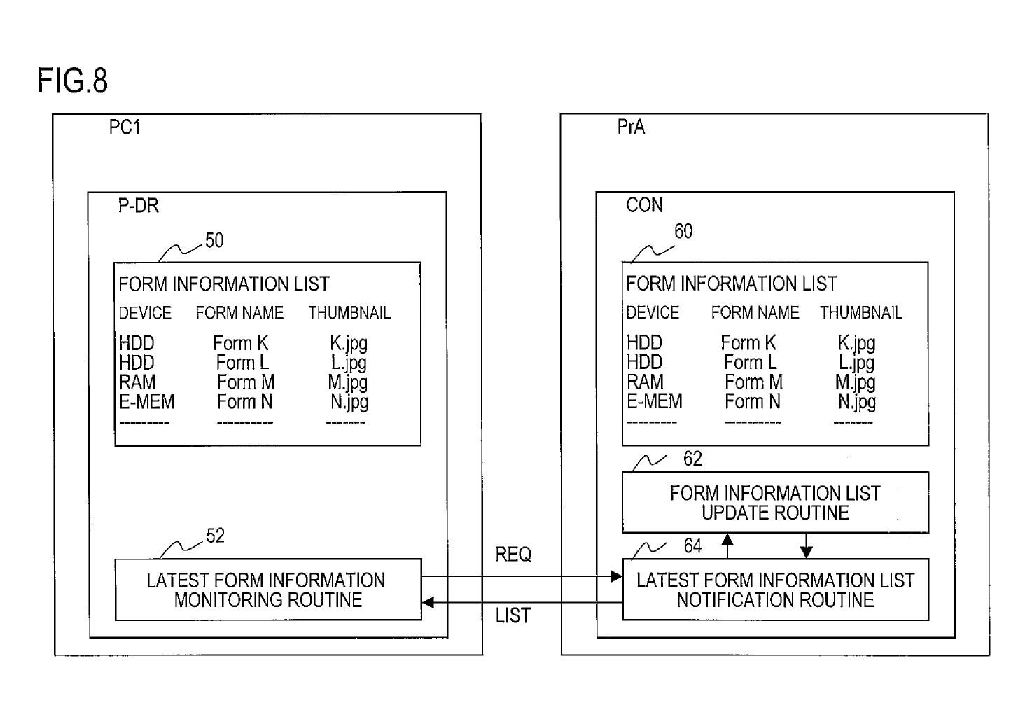

FIG. 8 is a diagram showing configurations of the printer driver and the printer controller of Modified Example 1 of the present embodiment. The printer driver P-DR and the printer controller CON maintain form information lists 50, 60 in the corresponding recording media, respectively. Each of the both form information lists 50, 60 has a form name and thumbnail data (or data on a data storage place) that are recorded or registered in the corresponding devices (recording media).

Moreover, the printer controller CON is installed with a form information list update routine 62 and a latest form information list notification routine 64. The printer driver P-DR has a latest form information monitoring routine 52. The form information list update routine 62 constantly monitors the changes of the condition of the printer and brings the form information list 60 up to date. Furthermore, the latest form information monitoring routine 52 provided within the printer driver P-DR requests the printer controller CON the latest form information items on regular basis (REQ), and the latest form information list notification routine 64 provided within the printer controller CON returns the updated latest form information items (LIST). Accordingly, the latest form information monitoring routine 52 can bring the form information items of the form information list 50 up to date.

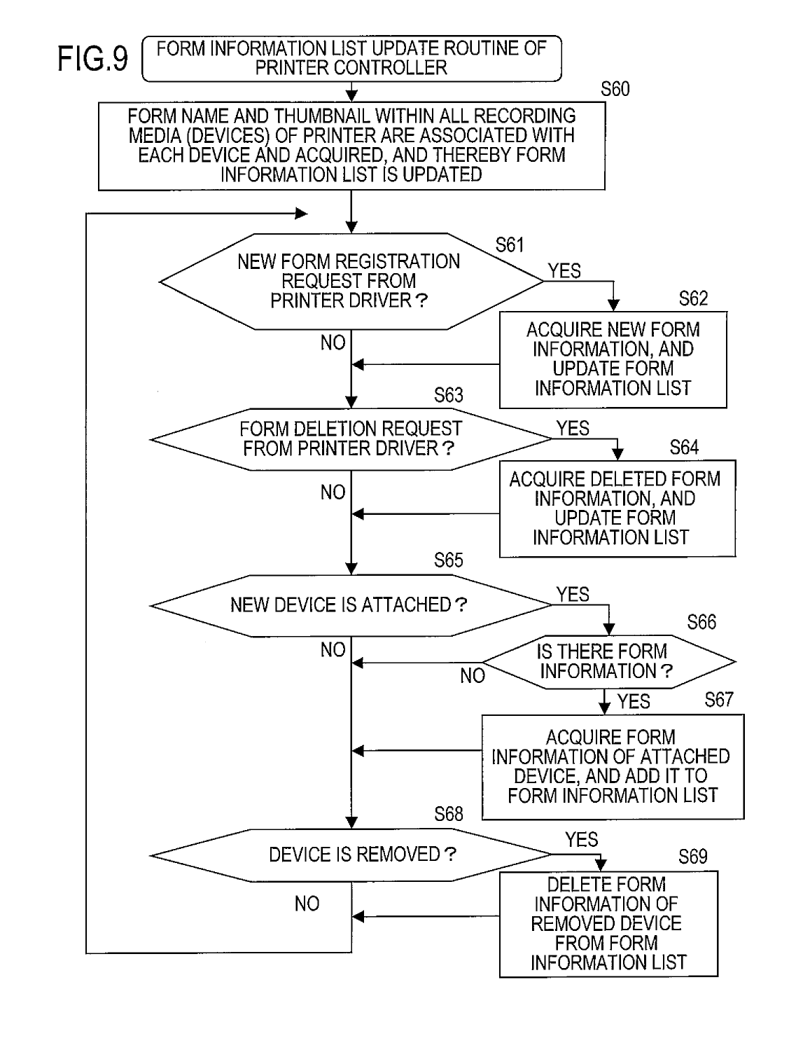

FIG. 9 is a flowchart showing a procedure of the form information list update routine 62. The form information list update routine 62 is activated when the printer is powered on, constantly monitors the changes in the form information items within the printer, and updates the form information list to have the latest form information items. As shown in FIG. 9, when activated, the form information list update routine 62 associates the form names and the thumbnail data, which are recorded in all of the devices (recording media) of the printer, with each device and acquires them, and thereby updates the form information list 60. The form information list 60 has the form names and thumbnail data (or data storage positions) of images of the forms in correspondence with the devices (storage media), as shown in FIG. 8.

Also, when the printer driver P-DR sends a new form registration request (YES in S61), the form information list update routine 62 acquires new form information items (form name, device information, thumbnail data and the like) from the printer driver, and adds these form information items to the form information list 60 within the printer (S62). When, however, the printer driver P-DR sends a form deletion request (YES in S63), the form information list update routine 62 acquires the form information items to be deleted (form name and device information) from the printer driver, and deletes these form information items (form name, device information, thumbnail data and the like) from the form information list 60 within the printer (S64).

Furthermore, when a new device (recording medium) is attached to the printer (YES in S65), the form information list update routine 62 searches within the attached device to check whether there are form information items (S66). When there are form information items (YES in S66), the form information list update routine 62 acquires the form information items (form name, thumbnail data and the like) from the device and adds these form information items to the form information list 60 within the printer (S67). When, however, the device (recording medium) is removed from the printer (YES in S68), the form information list update routine 62 deletes the form information items of this device (form name, device information, thumbnail data and the like) from the form information list 60 (S69). Attachment and removal of the device can be detected by an interface to which the device is attached, by using a known technology (e.g. USB interface).

The form information list update routine 62 constantly monitors the conditions of the devices of the printer and the form information items within the devices by repeatedly executing the abovementioned procedures S61 through S69. Accordingly, the form information list update routine 62 can maintain the form information list 60 up-to-date.

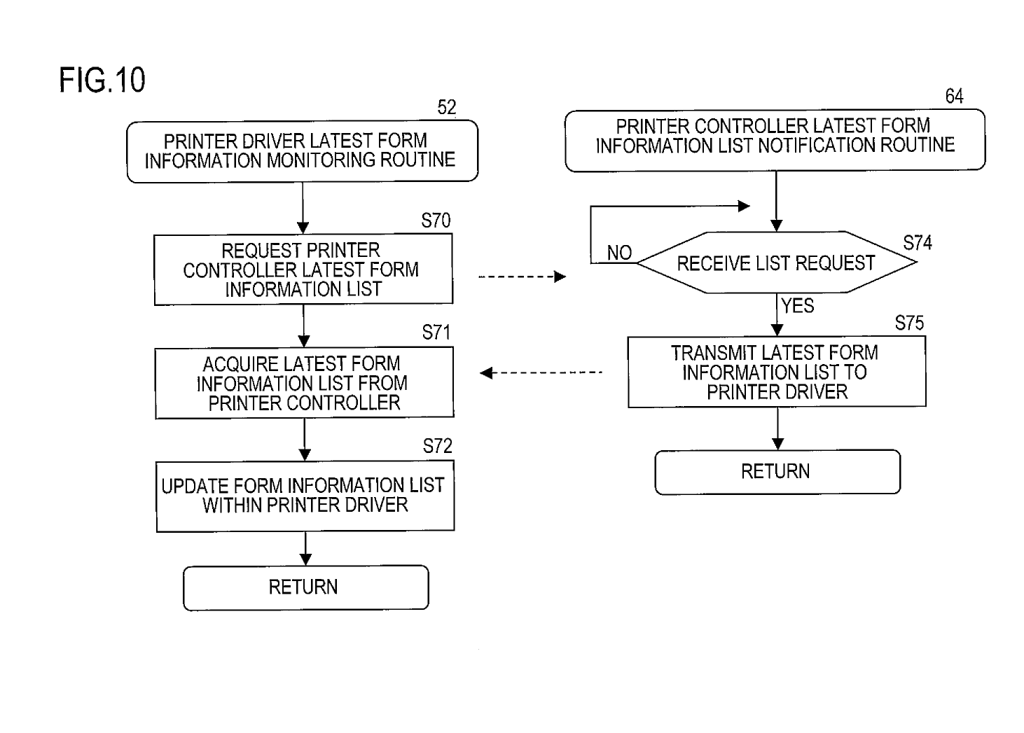

FIG. 10 is flowcharts of the latest form information monitoring routine 52 and the latest form information list notification routine 64 of Modified Example 1. In Modified Example 1, the latest form information monitoring routine 52 of the printer driver P-DR requests the printer controller CON the latest form information list on regular basis (S70). The latest form information notification routine 64 that receives this request (YES in S74) acquires the latest form information list from the form information list update routine 62 and transmits it to the printer driver P-DR (S75). This update form information list to be transmitted may be the differential data between the information items of the form information list 60 that were transmitted previously and the information items of the form information list 60 that are transmitted this time, or may be all data contained in the form information list 60. The latest form information monitoring routine 52 of the printer driver brings the form information list 50 up to date on the basis of the received latest form information list (S72). Both of the routines 52, 64 repeatedly execute the above procedures.

As described above, in Modified Example 1 the latest form information monitoring routine 52 requests the printer controller the latest form information list, acquires it on regular basis, and synchronizesthe form information list 50 of the printer driver P-DR with the form information list 60 of the printer controller CON. Then, when the user selects the form setting window, the printer driver P-DR reflects the updated form information list 50 in the recording medium selection portion 12 and the form list portion 14.

### MODIFIED EXAMPLE 2

In this modified example, the controller CON within the printer monitors the changes in the condition of the printer. Specifically, the controller CON constantly monitors whether the forms recorded in the recording media attached to the printer are registered or deleted, and whether the portable memories (external memory E-MEM etc.) are attached or detached, and, when there is a change in the condition, notifies the printer driver P-DR provided within the host computer of the information on such a change. Accordingly, the printer driver can constantly update the recording media attached to the printer and the form information items contained in the recording media in the list buffer. Then, when the user selects the form setting window, the printer driver P-DR reflects the updated form information items in the recording medium selection portion 12 and the form list portion 14.

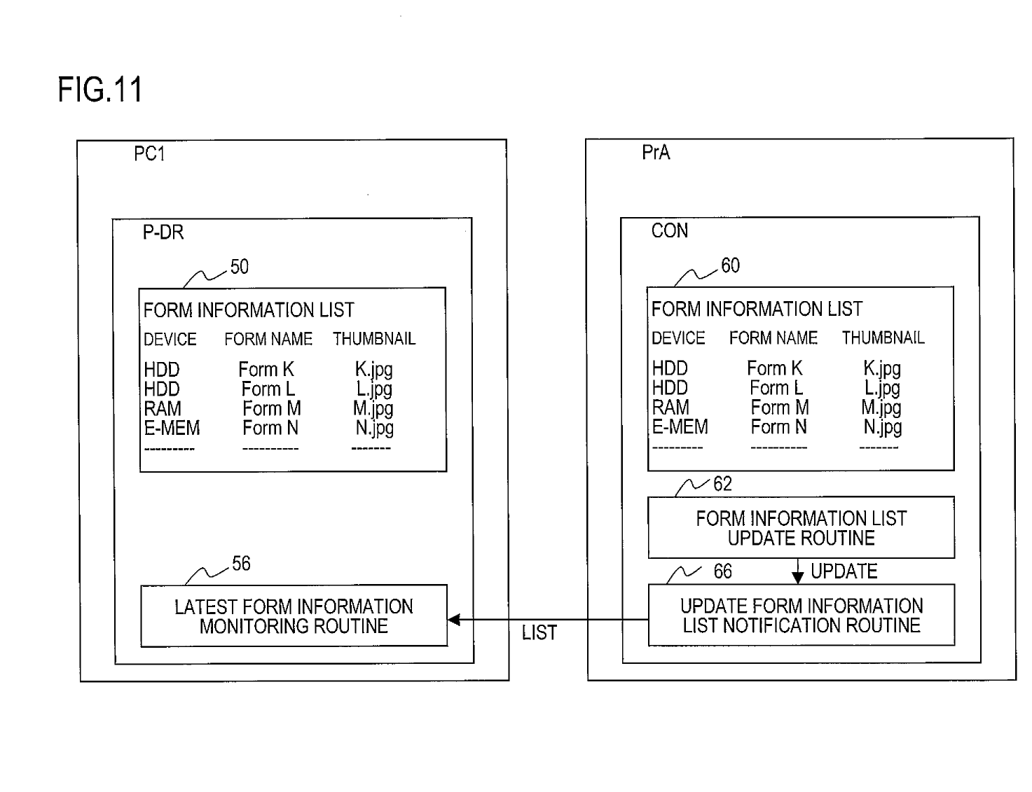

FIG. 11 is a diagram showing configurations of the printer driver and the printer controller of Modified Example 2 of the present embodiment. As with Modified Example 1 of FIG. 8, in Modified Example 2 the printer driver P-DR and the printer controller CON maintain, respectively, the form information lists 50, 60 within each of the recording medium. Moreover, each of the both form information lists 50, 60 has a form name and thumbnail data (or data on a data storage place) that are registered in the corresponding devices (recording media).

Moreover, the printer controller CON is installed with the form information list update routine 62 and a latest form information list notification routine 66. The printer driver P-DR has a latest form information monitoring routine 56. The form information list update routine 62 within the printer controller CON is same as the one of Modified Example 1, which constantly monitors the changes in the information items of the printer and brings the form information list 60 up to date, as shown in FIG. 9. Every time when the form information list 60 is updated, the latest form information list notification routine 66 provided within the printer controller CON transmits the updated form information items (LIST) to the printer driver P-DR. In response to this, the latest form information monitoring routine 56 provided within the printer driver receives the updated form information items and brings the form information items of the form information list 50 up to date.

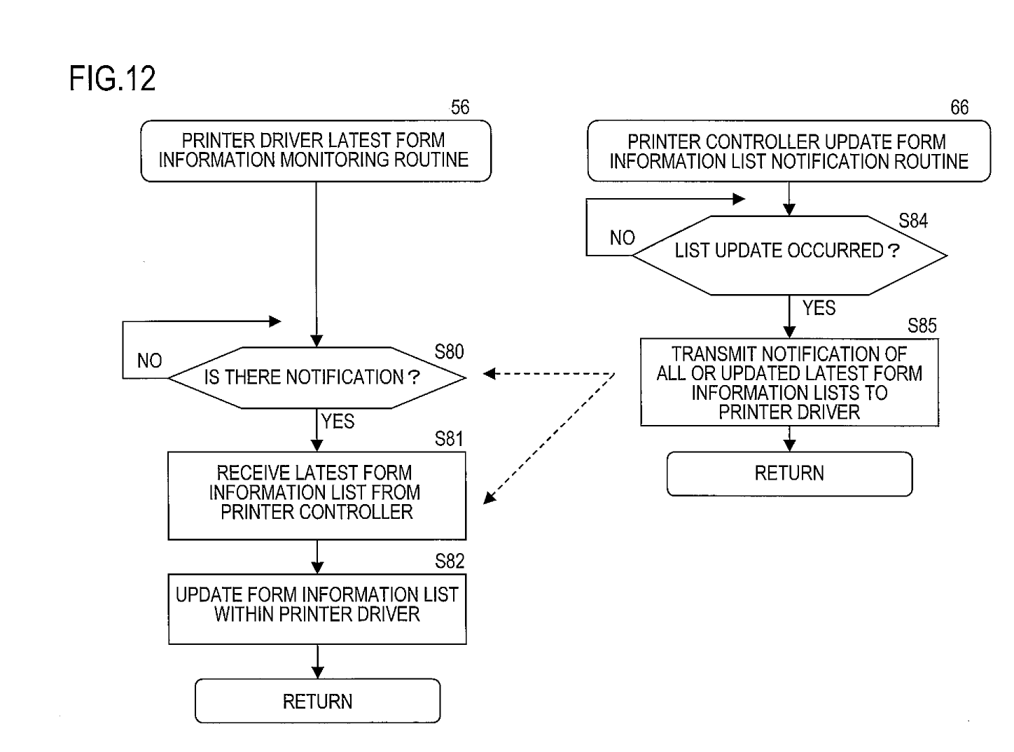

FIG. 12 shows flowcharts of a latest form information monitoring routine 56 and the latest form information list notification routine 66 of Modified Example 2. In Modified Example 2, every time when the form information list update routine 62 provided within the printer controller updates the form information list 60, the update form information list notification routine 66 is notified of list update (YES in S84) and, in respond to this, transmits to the printer driver a notification of a latest form information list (device name, form name, thumbnail data) (S85). This latest form information list to be transmitted may be the differential data between the information items of the form information list 60 that were transmitted previously and the information items of the form information list 60 that are transmitted this time, or may be all data contained in the form information list 60.

The latest form information monitoring routine 56 provided within the printer driver P-UR receives the latest form information items (S81) in response to this notification (YES in S80), and brings the form information list 50 up to date on the basis of the latest form information items (S82). Both of the routines 56, 66 repeatedly execute the above procedures.

Because the latest form information monitoring routine 56 maintains the form information list 50 up-to-date, when the user selects the form setting window the printer driver P-DR can reflect the updated form information items in the recording medium selection portion 12 and the form list portion 14.

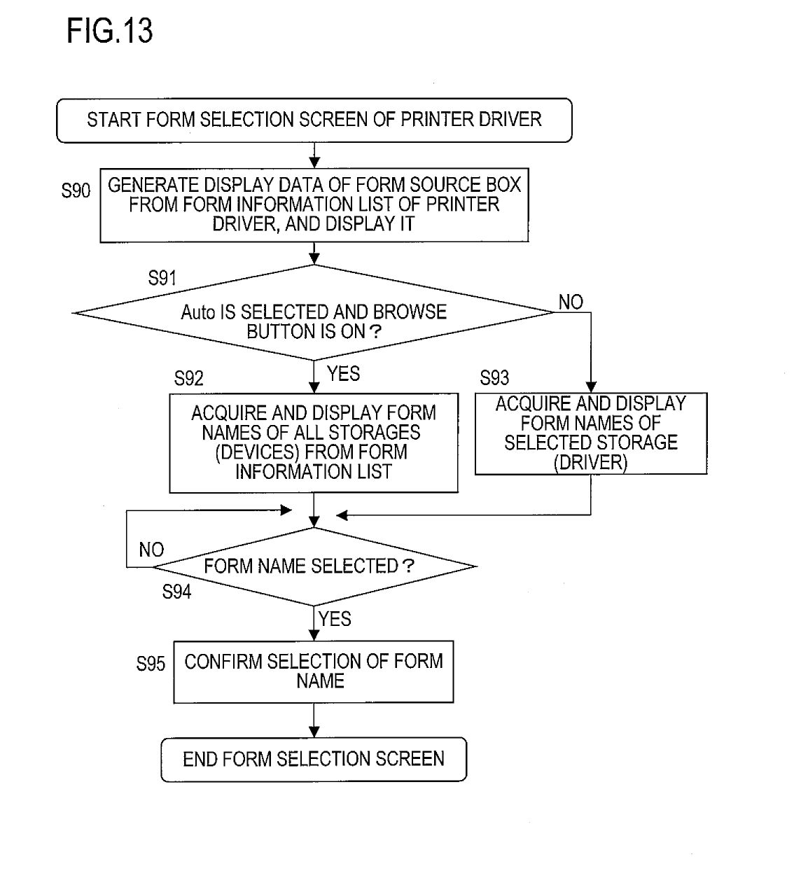

FIG. 13 is a processing flowchart of the printer driver shown in the form selection window of Modified Examples 1 and 2. FIG. 13 is a flowchart corresponding to FIG. 6.

As shown in FIG. 13, when the user selects the form selection window, the printer driver generates display data of a form source box from the form information list 50, and displays the display data (S90). Then, when the user selects the virtual recording medium Auto and clicks the browse button (YES in S91), the printer driver acquires the form names of all of the devices (recording media) from the form information list 50, and displays them on the form list portion 14 (see FIG. 2) (S92). When the user selects a recording medium other than the virtual recording medium Auto (NO in S91), the printer driver acquires the form name of the selected device (recording medium) from the form information list 50, and displays it on the form list portion 14 (S93). Furthermore, when the user selects a form name within the form list portion (YES in S94), the printer driver confirms the selection of the form name (S95).

As described above, in Modified Examples 1 and 2, the latest form information list is updated and maintained by the printer controller and the printer driver, regardless of the operations performed by the user. Then, when the user selects the form selection window, the information items of the latest form information list, that is, the devices (recording media) and the form names, are reflected in the form selection window.

As described above, according to the present embodiment, the printer can attach the external memory detachably, and the form information items stored in the attached external memory can be reflected in the form selection window of the printer controller. Accordingly, the print object image can be superimposed on a form image by using the form information items of the external memory, and the image of the application can be printed out easily.

According to the embodiment described above, in a printer driver program, which is installed in a host computer and controls a print job request sent to a printer, a computer is caused to execute a batch display procedure for, in response to batch designation for designating all of a plurality of recording media incorporated in or attached to the printer, displaying form information items recorded in the plurality of recording media of the printer onto the host computer, during a form overlay setting step. The form information items are collected by the printer driver sending a request to the controller in response to the batch designation of the recording media. Alternatively, the printer controller may update the form information items recorded in the incorporated or externally attached recording media at all times and maintain the latest form information list, and the printer driver may accordingly collect or receive this form information list, whereby the form information items may be collected. By providing the printer driver with the abovementioned function, the convenience of the user in using the form overlay can be improved.

According to the embodiment described above, in a printer driver program, which is installed in a host computer and controls a print job request sent to a printer, a computer is caused to execute a display procedure for, in response to designation of an external recording medium attached to the printer, displaying a form information item recorded in the external recording medium onto the host computer, during a form overlay setting step. Because the printer driver program can collect and display the form information items recorded within the external recording medium, it is not necessary to incorporate in the printer a recording medium for recording the form information items, and the same function as the built-in recording medium can be provided to the external recording medium attached to the printer, such as a USB connecting memory.

What is claimed is:

1. A printer driver program, which is installed in a host computer and controls a print job request sent to a printer, wherein a computer is caused to execute:
a batch display procedure for, in response to batch designation for designating all of a plurality of recording media to be incorporated in or attached to the printer, extracting from the printer form information items that are already registered in the plurality of recording media of the printer and then displaying the extracted form information items onto the host computer, during a form overlay setting step; and
an individual display procedure for, in response to individual designation for designating any of the plurality of recording media to be incorporated in or attached to the printer, extracting from the printer form information items that are already registered in the designated recording medium and then displaying the extracted form information items onto the host computer, during the form overlay setting step.

2. The printer driver program according to claim 1, wherein the computer is further caused to execute a transfer procedure for transferring, in response to selection of a form information item from among the displayed form information items, print data and the selected form information item to the printer as print jobs, during the form overlay setting step.

3. The printer driver program according to claim 1, wherein in the batch display procedure the plurality of extracted form information items are displayed in a display order corresponding to priority levels set for the plurality of recording media.

4. The printer driver program according to claim 1, wherein in the batch display procedure, recording medium information items corresponding to the extracted form information items are displayed so as to correspond to the form information items.

5. A printer system, comprising:
the printer driver program described in any of claims 1 through 4; and
a printer to which an external recording medium can be attached and which, in response to a request of a print job that is sent from the host computer, reads from the recording medium form data corresponding to form information items contained in the print job, superimposes a print image of print data contained in the print job on a form image of the form data, and prints thus obtained image.

6. A printer driver program, which is installed in a host computer and controls a print job request sent to a printer, wherein a computer is caused to execute a batch display procedure for, in response to batch designation for designating all of a plurality of recording media incorporated in or attached to the printer, displaying form information items recorded in the plurality of recording media of the printer onto the host computer, during a form overlay setting step.

7. The printer driver program according to claim 6, wherein the computer is further caused to execute a latest form information monitoring procedure for maintaining the form information items up-to-date at the appropriate time, the form information items being recorded in the recording media incorporated in or attached to the printer.

8. The printer driver program according to claim 7, further comprising a procedure for recording a form information list, which has at least a form name corresponding to each of the recording media, in a recording media of the host computer, wherein the latest form information monitoring procedure has a procedure for requesting a controller of the printer latest form information items on regular basis, and a procedure for receiving, in response to the request, the latest form information items that are transmitted by the controller of the printer and then updating the form information list.

9. The printer driver program according to claim 7, further comprising a procedure for recording a form information list, which has at least a form name corresponding to each of the recording media, in a recording media of the host computer, wherein the latest form information monitoring procedure has a procedure for receiving latest form information items that are transmitted by a controller of the printer in response to changes in the conditions of the recording media, and then updating the form information list.

10. A printer driver program, which is installed in a host computer and controls a print job request sent to a printer, wherein a computer is caused to execute a display procedure for, in response to designation of an external recording medium attached to the printer, displaying a form information item recorded in the external recording medium onto the host computer, during a form overlay setting step.

11. A printer system, comprising:
the printer driver program described in any of claims 6 through 10; and
a printer to which an external recording medium can be attached and which, in response to a request of a print job that is sent from the host computer, reads from the recording medium form image data corresponding to form information items contained in the print job, superimposes a print object image of print data contained in the print job on a form image of the form image data, and prints thus obtained image.
